(19) United States
(12) Patent Application Publication
(10) Pub. No.: US 2022/0400706 A1
(43) Pub. Date: Dec. 22, 2022

(54) PROCESS OF COATING DRIED KIBBLES WITH PROBIOTICS USING FAT AS A CARRIER, AND COATED KIBBLES MADE BY SUCH METHODS

(71) Applicant: Société des Produits Nestlé S.A., Vevey (CH)

(72) Inventors: Thalles Coelho, Fenton, MO (US); Ivan Filipi, St Louis, MO (US); John Schaaf, Edwardsville, IL (US)

(21) Appl. No.: 17/835,736

(22) Filed: Jun. 8, 2022

Related U.S. Application Data
(60) Provisional application No. 63/211,103, filed on Jun. 16, 2021.

(51) Int. Cl. A23K 40/30; A23K 50/42; A23K 10/20; A23K 10/18; A23K 10/30; A23K 20/158

(52) U.S. Cl. CPC A23K 40/30; A23K 50/42; A23K 10/20; A23K 10/18; A23K 10/30; A23K 20/158

(57) ABSTRACT

A method of making a pet food product includes: mixing (a) a powder containing one or more probiotics and (b) a first portion of liquid fat using a high shear mixer, to form a liquid mixture containing the one or more probiotics dispersed in the first portion of liquid fat and mixing a second portion of liquid fat with the liquid mixture, to form a coating composition containing the one or more probiotics and the first and second portions of liquid fat; and coating a food kibble with the coating composition using a batch or continuous coating device, to form the pet food product.

### CROSS REFERENCE TO RELATED APPLICATIONS

This application claims the benefit of and priority to U.S. Provisional Application Ser. No. 63/211,103 filed Jun. 16, 2021, the disclosure of which is incorporated in its entirety herein by this reference.

### BACKGROUND

Probiotics are living microorganisms that are naturally sensitive to heat and moisture. They cannot survive pet food processing conditions, which includes HTST (high temperature/short time) operations, such as extrusion and retorting. One way to address this issue is to use a dry coating blend of a powder digest and a probiotic. However, dried digest is significantly more costly than liquid digest. Furthermore, this process can have variability, and in some cases, overdosing is required to ensure that target amounts are reached.

### SUMMARY

Applicant recognized that probiotics incorporated in a lipid, then used for coating edible products, adds extra protection to the viable cells, thereby preventing premature germination. An additional benefit is the recovery of the probiotics in finished product. The challenge of this process is how to keep the probiotics uniformly distributed in the lipid, especially for industrial size applications. For example, in dry pet food factories, the total volume of lipid required in the coating process can be higher than 50 gallons per minute (gpm); and an efficient blend which keeps the probiotics in suspension for long periods, without clumping, lipid degradation, and/or inconsistent dosing may be impractical.

The present disclosure generally relates to a method for coating food kibble with a coating composition comprising one or more probiotics. More specifically, the present disclosure is directed to a method comprising preparing a concentrated dispersion of one or more probiotics using a first portion of liquid lipid and then mixing the concentrated dispersion of one or more probiotics with a second portion of liquid lipid to form a coating composition which can then be sprayed on a food kibble.

Therefore, one aspect of the present disclosure is a method of making a pet food product comprising mixing (a) a powder comprising one or more probiotics and (b) a first portion of liquid lipid using a high shear mixer to form a liquid mixture comprising the one or more probiotics dispersed in the first portion of liquid lipid. The method may also comprise transferring the liquid mixture to a day tank. The method may further comprise inline mixing a second portion of the liquid lipid with the liquid mixture from the day tank to form a coating composition. The mixing of the second portion of the liquid lipid with the liquid mixture from the day tank may occur in a fluid line downstream from the day tank and upstream from a coater and may use a static mixer to promote a uniform blend. The method may further comprise coating a food kibble with the coating composition to form a pet food product.

Another aspect of the present disclosure, is a coated pet food kibble made by the method disclosed herein.

An advantage of one or more embodiments provided by the present disclosure is a uniform and consistent coating comprising one or more probiotics on a food kibble.

Another advantage of one or more embodiments provided by the present disclosure is a process for coating food kibble with a composition comprising one or more probiotics, wherein the process is stable over time.

Another advantage of one or more embodiments provided by the present disclosure is ensuring a minimum pre-determined concentration of probiotics in a finished food product (e.g. food kibble).

Another advantage of one or more embodiments provided by the present disclosure is ensuring a minimum pre-determined concentration of probiotics in a finished food product (e.g. food kibble) without the need for overdosing, thereby realizing a cost savings.

Additional features and advantages are described herein and will be apparent from the following Detailed Description and the Figures.

### BRIEF DESCRIPTION OF THE FIGURES

FIG. 1 is a basic process flow diagram for an embodiment of a system disclosed herein.

FIGS. 2a and 2b are graphs showing the amount of probiotics recovered in lipid sample and in finished product, respectively, for Example 1.1 disclosed herein.

FIGS. 3a and 3b are graphs showing the amount of probiotic recovered in finished product and in lipid, respectively, for Example 1.4 disclosed herein.

FIGS. 4a and 4b are graphs showing the amount of probiotic recovered in finished product and in lipid sample, respectively, for Example 1.4 disclosed herein.

FIGS. 5a and 5b are graphs showing the amount of probiotic recovered in lipid samples and acidified lipid samples and the pH of the respective compositions for BC30 and Calsporin®, respectively, for Example 1.5 disclosed herein.

### DETAILED DESCRIPTION

As used in this disclosure and the appended claims, the singular forms “a,” “an” and “the” include plural referents unless the context clearly dictates otherwise. Thus, for example, reference to “a compound” or “the compound” includes a single compound and also two or more compounds.

The words “comprise,” “comprises” and “comprising” are to be interpreted inclusively rather than exclusively. Likewise, the terms “include,” “including” and “or” should all be construed to be inclusive, unless such a construction is clearly prohibited from the context. However, the compositions disclosed herein may lack any element that is not specifically disclosed. Thus, a disclosure of an embodiment using the term “comprising” includes a disclosure of embodiments “consisting essentially of” and “consisting of” the components identified. Similarly, the methods disclosed herein may lack any step that is not specifically disclosed herein. Thus, a disclosure of an embodiment using the term “comprising” includes a disclosure of embodiments “consisting essentially of” and “consisting of” the steps identified. Any embodiment disclosed herein can be combined with any other embodiment disclosed herein.

The terms “at least one of” and “and/or” used respectively in the context of “at least one of X or Y” and “X and/or Y” should be interpreted as “X without Y,” or “Y without X,” or “both X and Y.” Where used herein, the terms “example” and “such as,” particularly when followed by a listing of terms, are merely exemplary and illustrative and should not be deemed to be exclusive or comprehensive.

All percentages expressed herein are by weight of the total weight of the composition unless expressed otherwise. As used herein, “about” is understood to refer to numbers in a range of numerals, for example the range of −10% to +10% of the referenced number, preferably within −5% to +5% of the referenced number, more preferably within −1% to +1% of the referenced number, most preferably within −0.1% to +0.1% of the referenced number.

The terms “food,” “food product” and “food composition” mean a product or composition that is intended for ingestion by an animal and provides at least one nutrient to the animal. The term “animal” or “pet” means any animal which could benefit from or enjoy the food compositions and products provided by the present disclosure. The pet can be an avian, bovine, canine, equine, feline, hircine, lupine, murine, ovine, or porcine animal. The pet can be any suitable animal, and the present disclosure is not limited to a specific pet animal. The term “companion animal” means a dog or a cat.

The term “pet food” means any composition formulated to be consumed by a pet. A “dry” food composition has less than 10 wt. % moisture and/or a water activity less than 0.64, preferably both. A “semi-moist” food composition has 11 wt. % to 20 wt. % moisture and/or a water activity of 0.64 to 0.75, preferably both. A “wet” food composition has more than 20 wt. % moisture and/or a water activity higher than 0.75, preferably both.

“Kibbles” are pieces of dry pet food which can have a pellet shape or any other shape. Non-limiting examples of kibbles include particulates; pellets; pieces of pet food, dehydrated meat, meat analog, vegetables, and combinations thereof; and pet snacks, such as meat or vegetable jerky, rawhide, and biscuits. The present disclosure is not limited to a specific form of the kibbles.

“Probiotic” means microbial cell preparations or components of microbial cells with a beneficial effect on the health or well-being of the host. (Salminen S, Ouwehand A. Benno Y. et al “Probiotics: how should they be defined” Trends Food Sci. Technol. 1999:10 107-10).

The term “lipid” as used herein refers to a class of organic compounds that is insoluble in water but is soluble in non-polar organic solvents. Non-limiting examples includes fats and oils. In some instances, the terms “lipid” and “fat” are used interchangeably herein.

The methods and compositions and other advances disclosed herein are not limited to particular methodologies, protocols, and reagents because, as the skilled artisan will appreciate, they may vary. Further, the terminology used herein is for the purpose of describing particular embodiments only and does not limit the scope of that which is disclosed or claimed.

Unless defined otherwise, all technical and scientific terms, terms of art, and acronyms used herein have the meanings commonly understood by one of ordinary skill in the art in the field(s) of the present disclosure or in the field(s) where the term is used. Although any compositions, methods, articles of manufacture, or other means or materials similar or equivalent to those described herein can be used, exemplary devices, methods, articles of manufacture, or other means or materials are described herein.

Embodiments provided by the present disclosure are described hereafter. An aspect of the present disclosure is a method of making a pet food product, the method comprising: mixing (a) a powder comprising one or more probiotics and (b) a first portion of liquid lipid using a high shear mixer, to form a liquid mixture comprising the one or more probiotics dispersed in the first portion of liquid lipid.

The method further comprises transferring the liquid mixture to a day tank.

The method further comprises mixing a second portion of liquid lipid with the liquid mixture, at a position in a fluid line downstream from the day tank and upstream from a coater, to form a coating composition comprising the one or more probiotics and the first and second portions of liquid lipid.

The method further comprises coating a food kibble with the coating composition using the coater to form the pet food product.

In some embodiments, the mixing (a) the powder comprising one or more probiotics and (b) the first portion of liquid lipid comprises a batch tank configured with the high shear mixer. In some embodiments, the high shear mixer is configured within the batch tank. In other embodiments, the high shear mixer is configured in-line with the batch tank.

In some embodiments, the coating a food kibble with the coating composition comprises a batch coater. In some embodiments the coating a food kibble with the coating composition comprises a continuous coater.

In some embodiments, the day tank comprises an agitator and a recirculation loop. In one embodiment, the recirculation loop comprises a pump an a recirculating of the liquid mixture comprises using the pump.

In some embodiments, the coating of the food kibble with the coating composition comprises spraying the coating composition on the food kibble using the coater.

In some embodiments, a main storage lipid tank provides the first portion of liquid lipid, and the method comprises comprising transferring the first portion of liquid lipid from the main storage lipid tank to the batch tank. In some embodiments, the main storage lipid tank also provides the second portion of liquid lipid (e.g., the first and second portions of liquid lipid are the same type of lipid, which is provided by the lipid tank, such as tallow, chicken fat, edible lard, vegetable oil or mixtures thereof). In such embodiments, the method comprises transferring the second portion of liquid lipid from the main storage lipid tank to the position in the fluid line, downstream from the day tank and upstream from the static mixer.

In some embodiments, a combination of the second portion of liquid lipid and the liquid mixture is subjected to homogenization in a static mixer in the fluid line to form the coating composition (e.g., downstream of the batch tank and/or the day tank, and upstream of the coater).

In some embodiments, a concentration of the one or more probiotics in the liquid mixture is from about 1.5% to about 15%.

In some embodiments, the coating composition has a total lipid volume defined by the first and second portions of liquid lipid, and the first portion of liquid lipid mixed with the powder is about 1% to about 95% of the total fat volume of the coating composition.

In some embodiments, the method comprises dosing the powder into at least one of the batch tank or the high shear mixer using a metered feeder or a manual feeder.

In some embodiments, the powder comprising one or more probiotics contains additional active ingredients in powder form. Non-limiting examples include, powder digest, tetrasodium pyrophosphate (TSPP), textured vegetable protein (TPV), dried spinach, chia seed, ancient grains (e.g. millet, quinoa, spelt, amaranth, or teff), buckwheat, sorghum, dried animal digest (DAD), yeast, seeds, whole egg, egg yolk, colostrum, oats, mushrooms, vitamins, minerals, colorants and mixtures thereof.

In one embodiment, the powder does not contain any other active ingredient. In another embodiment, the powder consists essentially of one or more probiotics.

In some embodiments, the first and second portions of liquid lipid are respectively dosed into the batch tank and the fluid line without any other ingredients in the first and second portions of liquid lipid (i.e., pure lipid). In some embodiments, the method comprises controlling a flow rate of the liquid mixture into or through the fluid line by a first dosing pump, based on data from a flow meter in the fluid line indicative of probiotic concentration in the liquid mixture. In some embodiments, the method comprises controlling a flow rate of the second portion of liquid fat into or through the fluid line by a second dosing pump, such that the flow rate of the liquid mixture and the flow rate of the second portion of liquid fat achieve a concentration of the one or more probiotics in the coating composition that is substantially equal to a predetermined target concentration of the one or more probiotics.

Another aspect of the present disclosure is a coated pet food kibble made by any method disclosed herein.

The experimental study disclosed later herein showed that incorporating probiotics into fat and using the mixture for coating kibbles is a feasible solution and delivers consistent results with excellent recovery of viable cells in the finished product. The process is also stable over time and capable of uniformly coating kibbles with probiotics.

In one embodiment, a system has a dedicated tank for batching the probiotics with the lipid (e.g. a batch tank). A high shear mixer is configured within the tank to disperse the probiotics into the lipid. The high shear mixer can efficiently homogenize and suspend solids in solution. The powder comprising one or more probiotics is fed into the batch tank using a hopper and metered feeder, such as a loss-in-weight or gravimetric feeder. Alternatively, a manual feeder is used.

In another embodiment, the mixing of the probiotics with the lipid occurs in a high shear mixer that is configured in-line with the batch tank. In such an embodiment, the high shear mixer is an in-line mixer and recirculates liquid from the batch tank through the mixer at high velocity. This mixer has a hopper where the powder is fed and when a valve in the bottom of the hopper is opened, the powder is pushed into the liquid stream. As the powder and liquid are introduced straight into the high shear zone of the mixer, they are instantaneously combined using mechanical and hydraulic shear. In some embodiments, flow rates in the high shear mixer are as high as 500 lb/min. In such an embodiment, it is advantageous to configure the high shear mixer close to the batch tank.

The batch tank may further comprise a recirculation loop comprising a pump. The recirculation loop provides an additional source of movement for the probiotic dispersion in fat which minimizes settling and clumping of the probiotics. The mixing time in both scenarios may be limited to a maximum of 10 minutes and a minimum of 30 seconds to guarantee the integrity of the viable cells and mixing uniformity.

In some embodiments, the one or more probiotics mixed with the first portion of liquid lipid is from about 1.5 wt. % to about 15.0 wt. % of the liquid mixture formed in the batch tank, although higher concentrations are also contemplated. The maximum concentration of probiotics in solution can be used to define the tank size, a high concentrated solution reduces the required flow rate, and as a consequence smaller size tanks can be used.

The probiotic ingredient can comprise one or more bacterial microorganisms suitable for pet consumption and effective for improving the microbial balance in the pet gastrointestinal tract or for other benefits, such as disease or condition relief or prophylaxis, to the pet. Various probiotic microorganisms are known in the art. In specific embodiments, the probiotic component may be selected from bacteria, yeast, or microorganisms of the genera Bacillus, Bacteroides, Bifidobacterium, Enterococcus (e.g. Enterococcus faecium DSM 10663 and Enterococcus faecium SF68), Lactobacillus, Leuconostroc, Saccharomyces, Streptococcus, and mixtures thereof. In other embodiments, the probiotic may be selected from the genera Bifidobacterium, Lactobacillus, and combinations thereof. Those of the genera Bacillus may form spores.

In some embodiments, the probiotic comprises Bacillus coagulans GBI-30 (BC30). BC30 is a strain of stable probiotic bacteria B. coagulans that has the ability to form a protective spore. This shell gives the ability to survive harsh manufacturing processes and extended ingredient shelf life. BC30 is commercially available from Ganeden Inc., is generally recognized as safe (GRAS) by the U.S. Food and Drug administration (FDA), has a minimum concentration of 15 billion (1.5E+10) cfu/gram and a shelf-life of twenty-four (24) months.

In some embodiments, the probiotic comprises Bacillus subtilis, such as Calsporin® which is an all-natural Bacillus subtilis (bacteria C-3102) and has been shown in research studies to increase beneficial gut organisms like Lactobacillus and Bifidobacterium. In the past, probiotics had the disadvantage of instability in feed production, and this problem was addressed by the spore-forming probiotics. When B. subtilis C-3102 turns into spores, it forms two layers of protein around it, and these layers protect the bacteria from environmental stressors, which make them very heat stable and can be easily pelleted up to 90° C. (194° F.) without reduction of survivability. B. subtilis C-3102 is commercially available from Quality Technology International, Inc., has a concentration of 1 billion CFU/g to 30 billion (3.00E+10) CFU/g, has a shelf-life of up to 36 months in unopened bags and up to 6 months in opened bags, and is generally recognized as safe (GRAS) by the U.S. Food and Drug administration (FDA). In other embodiments, the probiotic does not form a spore.

The term “colony forming units (CFU)” is a measure of the number of viable bacteria or fungi. Unlike the direct microscopy count, which includes not only living cells but also cells that are dead, CFU counts the viable cells. CFU is usually obtained as CFU per unit of material including CFU. Therefore, CFU is usually obtained in CFU/L or CFU/g of the substance including the colony forming units. CFU materials are usually evaluated by suspending a known quantity in a suitable liquid. The liquid then may be further diluted, using a liquid which is a suitable growth medium, for example, to be seeded in plates or suitable alternative transparent agar. For example, after twenty-four (24) hours of culture, the number of colonies formed on an agar medium make it possible to calculate the CFU of the substance.

The concentrated mixture of probiotic(s) and lipid can be combined with a lipid pipeline providing another portion of lipid. In one embodiment, the dilution of the concentrated mixture of probiotics occurs immediately preceding a coater device. A static mixer can be used to blend the probiotic lipid mixture with additional lipid from the main line. A processor or controller for the coater can adjust the flow rate from both streams to deliver a target amount of probiotics and lipid. In one embodiment, the method is a batch process. In this embodiment, the batch tank provides the probiotic lipid mixture directly to be combined with additional lipid from the main line. In another embodiment, the method is continuous process. In this embodiment, the probiotic lipid mixture from the batch tank is transferred to a day tank. The day tank serves as the continuous reservoir for the probiotic lipid mixture which is then combined with the additional lipid from the main line to form the coating composition.

Pet food formulas that include probiotics should ensure a minimum amount of viable cells in the finished product, otherwise, the probiotics benefit for the consumers will not be effective. Therefore, the dosing system is preferably accurate and stable. The system according to the present disclosure has a dedicated tank to batch the probiotics with fat. A high shear mixer can efficiently mix the combination, but to avoid solids settling, a pump and recirculation loop can be used in the batch tank and/or day tank to keep recirculating the solution back to the tank.

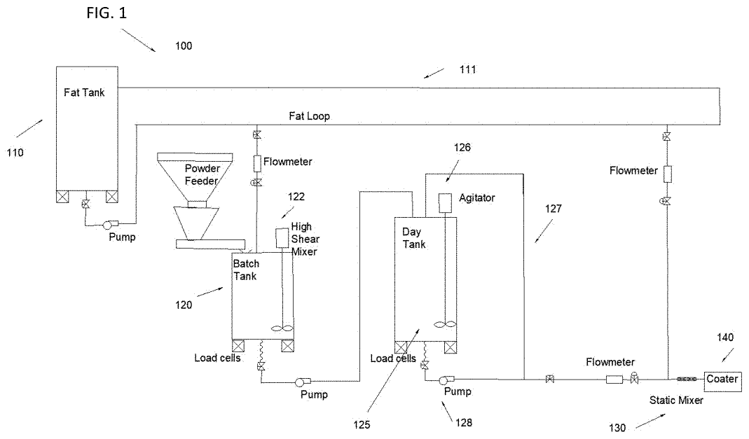

FIG. 1 shows a schematic diagram of a system 100 according to an embodiment of the present disclosure. In some embodiments, a main storage lipid tank 110 is filled with pure lipid, for example, a composition consisting of one or more lipids. The lipid from the lipid tank 110 can be transferred to a batch tank 120 to be combined with probiotics. Once the batching of the probiotics and lipid in the batch tank is complete, e.g. the probiotics and lipid have been dosed into the batch tank and the high shear mixer has produced a uniform dispersion of the probiotic in the lipid, the dispersion is transferred to a day tank 125. The day tank 125 provides a reservoir of probiotics at a consistent concentration for use by the coating process. The day tank 125 comprises an agitator 126 and is configured with a recirculation loop 127 comprising a pump 128 to ensure that the probiotics stay dispersed in the lipid during the process.

In some embodiments, the lipid comprises a fat or an oil. Non-limiting examples of fats include animal fats, for example, beef fat, pork fat, poultry fat. Non-limiting examples of oils include vegetable oils, such as corn oil, sunflower oil, safflower oil, rape seed oil, soybean oil, olive oil and other oils rich in monounsaturated and polyunsaturated fatty acids, and medium chain triglycerides can be used.

In some embodiments, acidification of the lipid with an organic acid (e.g., lactic acid) can prevent pathogens and biofilm on contact surfaces, and the acidification can be used in conjunction with mild heating and agitation to control the risks of contamination in the finished product. Non-limiting examples of organic acids include, succinic acid, pyruvic acid, fumaric acid, adipic acid, glucono-δ-lactone, tartaric acid, lactic acid, citric acid, malic acid, phosphoric acid, and mixtures thereof. In some embodiments, the lipid is not acidified.

The required amount of lipid and probiotics can be calculated based on the product needs (e.g., required amount of lipid), target amount of probiotics in finished product, and equipment limitations. As a non-limiting example, a kibble rate can be fixed at about 60 lb/min, the finished product probiotics requirement can be about 0.0279%, and the product can be coated with about 7.5 wt. % of fat. In this example, regardless of the concentration in the batch tank 120, the solution after the static mixer 130 is typically about 0.4% probiotic to achieve the target concentration in finished product. Control of a coater 140 can be modified to adjust the flow rate from the day tank 125.

A non-limiting exemplary embodiment of the system 100 follows. In some embodiments, the system 100 can be implemented in a dry pet food factory to use lipid as the carrier for probiotics. The system 100 can comprise one or more coaters 140, for example, each running at about 30 to 1000 lb/min kibble rate. In some embodiments, the system comprises one coater. In another embodiment, the system comprises two coaters. In yet another embodiment, the system comprises three coaters.

The system 100 may perform the first part of the process by executing a batch and transfer sequence. In the first part of the process, lipid and probiotics can be batched in the batch tank 120 to a target concentration. In one embodiment, the batch tank 120 has one or more of a circular cross-section, a self-supporting roof, and/or a conical bottom for draining. As a non-limiting example, the batch tank 120 can hold about sixty gallons (about 227 L) and/or is made with stainless steel.

In some embodiments, the batch tank 120 is mounted on three load cells that provide the input to the tank level alarms and the totalizer. Input to the weight totalizer can comprise a lipid flow rate measured by a flow meter. The batch tank 120 preferably has a high-high level probe to prevent overflows, e.g., by providing the input signal to close the supply valve and shut down the system 100 (e.g., one or more of a discharge pump, a Loss-in-Weight (LIW feeder), and/or an agitator). Additionally or alternatively, the load cells preferably monitor high and low levels. The low-low level probe can prevent the agitator running without fluid inside and/or stop the pump when discharging the solution.

In one embodiment, the batch tank 120 is equipped with a high shear mixer 122. High-shear mixing is typically used to disperse one phase or ingredient (herein the one or more probiotics) into a main continuous phase (herein the first portion of liquid fat). A rotor or impeller, together with a stationary component known as a stator, or an array of rotors and stators, may be used either in the batch tank 120 containing the liquid mixture, or in a pipe through which the liquid mixture passes, to create shear. The high shear mixer 122 may be any suitable device. For example, the high shear mixer 122 may be a rotor-stator high shear mixer.

The high shear mixing may be performed using a continuous in-line mixer (e.g. in a pipe) at a shear rate of approximately 5,000 to 500,000 s⁻¹, 5,000 to 400,000 s⁻¹ or 5,000 to 200,000 s⁻¹ for approximately 1 to 600 seconds. The high shear mixing may be performed using a shear rate of approximately 5,000 to 500,000 s⁻¹, 5,000 to 400,000 s⁻¹ or 5,000 to 200,000 s⁻¹ for approximately 1 to 300 seconds. The high shear mixing may be performed using a shear rate of approximately 5,000 to 500,000 s⁻¹, 5,000 to 400,000 s⁻¹ or 5,000 to 200,000 s⁻¹ for approximately 1 to 60 seconds. The high shear mixing may be performed using a shear rate of approximately 5,000 to 500,000 s⁻¹, 5,000 to 400,000 s⁻¹ or 5,000 to 200,000 s⁻¹ for approximately 30 seconds. In one embodiment the high shear mixing may be performed using a shear rate of approximately 50,000 s⁻¹ for approximately 5 seconds.

The high shear mixing may be performed using a batch or semi-continuous mixer (e.g. in the batch tank 120) at a shear rate of approximately 5,000 to 500,000 s⁻¹, 5,000 to 400,000 s⁻¹ or 5,000 to 200,000 s⁻¹ for approximately 0.5 to 10 minutes. The high shear mixing may be performed using a shear rate of approximately 5,000 to 500,000 s⁻¹, 5,000 to 400,000 s⁻¹ or 5,000 to 200,000 s⁻¹ for approximately 1 to 5 minutes. The high shear mixing may be performed using a shear rate of approximately 5,000 to 500,000 s⁻¹, 5,000 to 400,000 s⁻¹ or 5,000 to 200,000 s⁻¹ for approximately 0.5 to 1 minutes. The high shear mixing may be performed using a shear rate of approximately 5,000 to 500,000 s⁻¹, 5,000 to 400,000 s⁻¹ or 5,000 to 200,000 s⁻¹ for approximately 0.5 minutes. In one embodiment the high shear mixing may be performed using a shear rate of approximately 50,000 s⁻¹ for approximately 1 minute.

In some embodiments, the batch tank 120 is associated with a temperature sensor to monitor and prevent overheating and potential probiotics losses. The pipe in the recirculation loop can have a pressure regulator to keep the target pressure constant. A dedicated structure can support the mixer. Optionally the tank is insulated with heated blankets to prevent temperature losses.

Generally, the batching sequence starts with opening of the lipid supply control valve. An automatic on/off control valve can be interlocked with the high-high level probe and load cells, e.g., to prevent overflows in the batch tank 120. When the lipid filling process is finished, one or more operations can be performed: closing the supply valve, starting the agitator at high speed, and/or starting the LIW-Feeder to add a target amount of probiotics powder.

After the powder is added to lipid in the batch tank 120, the processor can shut down the agitator (e.g., after a predetermined time period after completion of addition, such as about three minutes). After agitator shutdown, the tank discharge valve can be opened, and the pump can start running at high speed to transfer the solution to the day tank 125, which performs recirculating of the liquid mixture. When the lipid level reaches the low-low level probe, the processor can shut down the transfer pump (e.g., after a predetermined time period after the lipid level reaches the low-low level probe). After the lipid/probiotics transfer finishes, the discharge valve can be closed, and the system 100 can enter idle mode until there is a request for a new batch sequence.

The second part of the process may comprise a day tank sequence. For example, in the sequence of transferring the solution of lipid/probiotics to the day tank 125, when the level inside the day tank 125 reaches the low-level probe, the recirculation pump may be started in direct response (e.g., substantially immediately). When the batch transfer sequence is concluded, a conventional agitator in the day tank 125 can be operated, preferably at high speed. The suspension of lipid and probiotics may be kept in constant movement inside the day tank 125 to thereby keep the solids in suspension and avoid solids settling.

The transfer of the lipid/probiotics solution from the day tank 125 to the coater 140, can start by opening the discharge On/Off valve. In some embodiments, one or more further process control valves can be opened, for example, to modulate the flow rate delivered to each liquid coater 140. In some embodiments, the pure lipid coming from the lipid loop 111 of the lipid tank 110 can be dosed by a control valve and combined with the stream coming out from the day tank 125. Both pipes may be connected together before a static mixer 130 that is positioned close to the coater's lipid drip tube.

The pet foods disclosed herein can be any food formulated for consumption by a pet such as a dog or cat. In an embodiment, the pet food provides complete nutrition as defined by the Association of American Feed Control Officials (AAFCO) and which depends on the type of animal for which the composition is intended (e.g., a dog or a cat).

The pet food can comprise meat, such as emulsified meat. Examples of suitable meat include poultry, beef, pork, lamb and fish, especially those types of meats suitable for pets. The meat can include any additional parts of an animal including offal. Some or all of the meat can be provided as one or more meat meals, namely meat that has been dried and ground to form substantially uniform-sized particles and as defined by AAFCO. Additionally or alternatively, vegetable protein can be used, such as pea protein, corn protein (e.g., ground corn or corn gluten), wheat protein (e.g., ground wheat or wheat gluten), soy protein (e.g., soybean meal, soy concentrate, or soy isolate), rice protein (e.g., ground rice or rice gluten) and the like.

The pet foods disclosed herein can comprise one or more of a vegetable oil, a flavorant, a colorant or water. Non-limiting examples of suitable vegetable oils include soybean oil, corn oil, cottonseed oil, sunflower oil, canola oil, peanut oil, safflower oil and the like.

Non-limiting examples of suitable flavorants include yeast, tallow, rendered animal meals (e.g., poultry, beef, lamb, pork), flavor extracts or blends (e.g., grilled beef), animal digests, and the like. Non-limiting examples of suitable colorants include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; and any suitable food colorant known to the skilled artisan.

The pet foods disclosed herein can optionally include additional ingredients, such as starches, humectants, oral care ingredients, preservatives, amino acids, fibers, prebiotics, sugars, animal oils, aromas, other oils additionally or alternatively to vegetable oil, salts, vitamins, minerals, probiotic microorganisms, bioactive molecules or combinations thereof.

Non-limiting examples of suitable starches include a grain such as corn, rice, wheat, barley, oats, potatoes, peas, beans, cassava, and the like, and mixtures of these grains, and can be included at least partially in any flour. Non-limiting examples of suitable humectants include salt, sugars, propylene glycol and polyhydric glycols such as glycerin and sorbitol, and the like. Non-limiting examples of suitable oral care ingredients include alfalfa nutrient concentrate containing chlorophyll, sodium bicarbonate, phosphates (e.g., tricalcium phosphate, acid pyrophosphates, tetrasodium pyrophosphate, metaphosphates, and orthophosphates), peppermint, cloves, parsley, ginger and the like. Non-limiting examples of suitable preservatives include potassium sorbate, sorbic acid, sodium methyl para-hydroxybenzoate, calcium propionate, propionic acid, and combinations thereof.

Specific amounts for each additional ingredient in the pet food compositions disclosed herein will depend on a variety of factors such as the ingredient included in the first edible material and any second edible material; the species of animal; the animal's age, body weight, general health, sex, and diet; the animal's consumption rate; the purpose for which the food product is administered to the animal; and the like. Therefore, the components and their amounts may vary widely.

### EXAMPLES

The following non-limiting examples further supports the compositions and methods disclosed herein.

### Example 1: Ingredients and Dosing

In a first formula used in an experimental test, the kibble was about 90.25 wt. % of the pet food, the fat was about 7.25 wt. % of the pet food, and the powder probiotic was about 2.50 wt. % of the pet food (i.e., 2.47 wt. % animal digest powder and 0.03 wt. % BC30 powder). In a second formula used in the experimental test, the kibble was about 90.25 wt. % of the pet food, the fat was about 9.5 wt. % of the pet food, the liquid probiotic was about 2.00 wt. % of the pet food, and the powder probiotic is about 0.03 wt. % of the pet food. The study also evaluated the impact of acidified fat (e.g., fat with lactic acid) in the recovery of the probiotics.

A minimum amount of CFU/g was defined based on human food requirements and was set to have 1.90E+09 CFU/lb or 4.18E+06 CFU/g (6.62 log 10). The variability in the analytical process is 0.5 log, so the minimum amount of probiotics in the finished product was established as 6.12 log 10.

Tables 1a and 1b show the calculations used to estimate the percentage of probiotics in the finished product and in the fat blend. These percentages were the reference for the trials.

TABLE 1a
Formulated amount of BC30 in coating and finished product

| Calculation of Probiotics | Value |
|---|---|
| Formulated Level (CFU/lb food) | 1.90E+09 |
| Formulated Level (CFU/g food) | 4.18E+06 |
| Guaranteed BC30 (CFU/g Probiotic) | 1.50E+10 |
| BC30 in finished product (%) | 0.02786 |
| Fat Application Level (%) | 7 |
| BC30 in Coating (%) | 0.3980 |

TABLE 1b
Formulated amount of Calsporin ® in coating and finished product

| Calculation of Probiotics | Value |
|---|---|
| Formulated Level (CFU/lb food) | 1.90E+09 |
| Formulated Level (CFU/g food) | 4.18E+06 |
| Guaranteed BC30 (CFU/g Probiotic) | 3.00E+10 |
| BC30 in finished product (%) | 0.01393 |
| Fat Application Level (%) | 7 |
| Calsporin ® in Coating (%) | 0.1990 |

Trials were performed to evaluate the dispersion of the probiotics in fat, define the maximum concentration, and simulate factory conditions. Tests with kibbles coated with lactic acid were performed in a batch coater and a continuous coater, and the process was validated with different fats and probiotics levels.

1.1 High Shear Mixer and Continuous Coater Trial

Different concentrations of probiotics with tallow were prepared to assess the uniformity of the dispersion. The resultant compositions were used to coat kibbles in the continuous coater. A high shear mixer was required to incorporate the probiotics into fat. The concentration of probiotics in the test varied from 1% to 10% in weight of fat, and was batched in a bucket with 35 lb of tallow. The mixing time was established in 3 minutes, but after just a few seconds of operation, the powder was totally incorporated to the solution, and there was no precipitation in the bottom of the tank.

The number of colonies of probiotics in the pure BC30 powder was used as a reference and to calculate the target values for the test. In this case, the expected amount of probiotics recovered in tallow or in the kibbles is a percentage of the value found in the pure powder as shown in the Table 2 below.

TABLE 2

| Sample | CFU/g | Log (CFU/g) |
|---|---|---|
| BC30 Probiotic Powder | 3.5E+10 | 10.54 |
| Recovery in 2% fat (Expected) | 7.00E+08 | 8.85 |
| Recovery in 0.4% fat (Expected) | 1.40E+08 | 8.15 |
| Recovery in Product 0.279% (Expected) | 9.77E+06 | 6.99 |

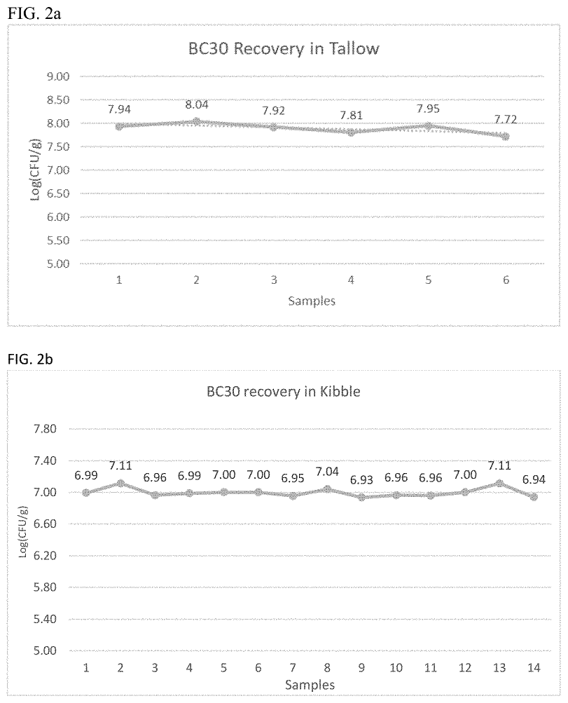

The concentrated solution had 7.60E+8 CFU/g or 8.88 Log (CFU/g). This concentrated solution was dumped in a tank and diluted to reach a concentration of 0.4% probiotics in the fat. The recovery of BC30 in the diluted solution for samples collected 5 minutes apart is shown in FIG. 2a.

The formula used in the test was 7.25% of fat with 0.4% of probiotics in it. With this mixture, it was possible to target the right amount of probiotics in finished product that is 0.0279% or 6.6 log 10. The continuous coater was used in the test. FIG. 2b shows the results of the BC30 recovery in the finished product. The samples averaged 7.0 log (CFU/g).

The test showed it is feasible to incorporate probiotics into fat and use the mixture for coating the product. The recovery of probiotics in the kibbles was above the minimum guaranteed formula level, which is 6.2 log. The test had one tank to batch the probiotics.

1.2 Continuous Process Trial

The process tested in the previous trial delivered consistent results, with a good probiotics recovery in the finished product. The process was modified for more flexibility to handle different fat rates and use different size tanks.

The system had two tanks: a first tank where probiotic was diluted in fat to a target concentration (“Batch Tank”) and a second tank with just fat. The fat tank combined with the batch tank delivers the target amount of fat and probiotics required by the formula. The previous trial tested probiotics concentrations up to 10%, and this trial tested concentrations of 0.88% and 3.23%. To have a uniform mixture, the probiotics were batched with fat in a bucket using a high shear mixer to incorporate the probiotics powder into the fat. The mixture was directed into the batch tank that was pre-filled with fat. An agitator mounted on top of the batch tank was used to keep the particles in suspension.

The flows from both tanks were then combined together, and passed through a static mixer to homogenize the blend. The flow rate in both tanks were controlled by a processor and could be adjusted for different kibble rates, fat rates, probiotics concentration in the tank, and percentage of probiotics in the finished product. The system can work continuously to keep filling the batch tank with fat mixed with probiotics.

The finished product was formulated to have 4.18E+06 CFU/g or 6.62 Log 10, which corresponds to 0.5 Log 10 more than the minimum acceptable amount of probiotics. The amount of coating and probiotics required are shown in Table 3. The probiotic rate is 0.3843% of the fat rate. In the trial, the continuous coater operated with a kibble rate of 60 lb/min.

TABLE 3
Coating Formulation

| | |
|---|---|
| Kibble (%) | 90.25 |
| Liquid or Powder Palatant (%) | 2.50 |
| Fat coating (%) | 7.25 |
| Kibble (lb/min) | 60 |
| Powder Coating (lb/min) | 1.6620 |
| Fat + probiotic (lb/min) | 4.8199 |
| Probiotic total (lb/min) | 0.0185 |
| Fat total (lb/min) | 4.8014 |

The flow rate in the batch tank was calculated based on the actual concentration of probiotics in the tank, in this case 0.88%, and the required amount of probiotics in coating (0.03843%).

Using a dilution equation, it is possible to define the required flow rate in the batch tank in the following way:

Batch tank (lb/min)=(% probiotic in coating/% probiotic in tank)*Total flow rate

Batch tank (lb/min)=(0.3843/0.88)*4.8199=2.105 lb/min

The flow rate in the storage fat tank is calculated in the following way:

Lipid Tank (lb/min)=Total_{Lipid+Probiotic}−Batch Tank

Lipid Tank (lb/min)=4.8199−2.105=2.7149 lb/min

To confirm if the probiotics dosing was correct, the amount of probiotics in lb/min coming from the batch tank was calculated. The batch tank had 0.88% of probiotics diluted in fat, and the flow rate of probiotics is 0.0185 lb/min, which match the values shown in Table 3.

This trial used two different concentrations of probiotics. The first test blended 1.96% of probiotics into fat using a high shear mixer and later dumped the solution in the batch tank to reach the target concentration of 0.88%. Samples were taken from the concentrated sample, in this case, a bucket where the probiotics were blended with fat using a high shear mixer, the batch tank (which also simulated a day tank), and after the static mixer (combined with the stream from the fat tank). The process was later repeated with higher concentrations. In this case, 6.97% of BC30 incorporated with fat using the high-shear mixer, then diluted to 3.23% in the batch tank and with 0.38% dilution rate after the static mixer. The expected values for each sample were calculated based on the CFU/g in the pure BC30 powder as shown in Table 4 below.

TABLE 4

| | Measured Values | | Calculated Values | |
|---|---|---|---|---|
| | | Log | | Log |
| | CFU/g | (CFU/g) | CFU/g | (CFU/g) |
| Sample Test A | | | | |
| Pure BC30 powder | 5.60E+10 | 10.75 | — | — |
| Concentrate (1.96%) | 6.20E+08 | 8.79 | 1.10E+09 | 9.04 |
| Dilution (0.88%) | 1.70E+08 | 8.23 | 5.60E+08 | 8.75 |
| Post Static Mixer | 1.40E+07 | 7.15 | 2.15E+08 | 8.33 |
| | 5.70E+07 | 7.76 | 2.15E+08 | 8.33 |
| | 2.00E+07 | 7.30 | 2.15E+08 | 8.33 |
| Sample Test B | | | | |
| Pure BC30 powder | 5.60E+10 | 10.75 | — | — |
| Concentrate (6.97%) | 3.80E+09 | 9.58 | 3.90E+09 | 9.59 |
| Dilution (3.23%) | 4.80E+08 | 8.68 | 1.81E+09 | 9.26 |
| | 5.60E+05 | 5.75 | 1.81E+09 | 9.26 |
| Post Static Mixer | 1.80E+07 | 7.26 | 2.15E+08 | 8.33 |
| | 4.40E+07 | 7.64 | 2.15E+08 | 8.33 |
| | 2.60E+07 | 7.41 | 2.15E+08 | 8.33 |

Kibbles were coated with the coating compositions described above. The recovery of probiotics in the kibbles averaged 6.94 Log 10. The target was defined as 0.0279% of 5.60E+10 CFU/g (pure BC30), which is equal to 7.2 Log 10. The lower specification limit is defined as 6.12. The concentration of probiotics in the tanks did not affect the results.

1.3 Trial: Test in the Batch Coater

The objective was to compare the probiotics recovery in kibbles coated with probiotics dispersed in fat (acidified with lactic acid) and probiotics blended with powder. The trial was performed in a batch coater and used a cat kibble Table 5 shows the target and measured values for each test.

TABLE 5

| | Measured Log | Target Log |
|---|---|---|
| | (CFU/g) | (CFU/g) |
| Powder digest + BC30 | 6.94 | 7.21 |
| | 6.97 | 7.21 |
| | 6.85 | 7.21 |
| | 6.91 | 7.21 |
| | 6.81 | 7.21 |
| | 7.00 | 7.21 |
| Fat + lactic acid + BC30 | 6.80 | 6.77 |
| | 6.94 | 6.77 |
| | 6.69 | 6.77 |
| | 6.75 | 6.77 |
| | 6.86 | 6.77 |
| | 6.69 | 6.77 |

The recovery in the samples with acidified fat was nearly at target or above. The recovery in samples coated with powder digest was slightly below the target.

1.4 Trial: Test in the Continuous Coater

The trial assessed the process for recovery of probiotic in fat and recovery of probiotic in the finished product. In this trial, one tank simulated the fat line from the factories and one simulated the batch tank where the pre-blended concentrated solution of probiotics and fat was diluted to a target concentration of 1% in tallow weight. One formula contained BC30 and one contained Calsporin®.

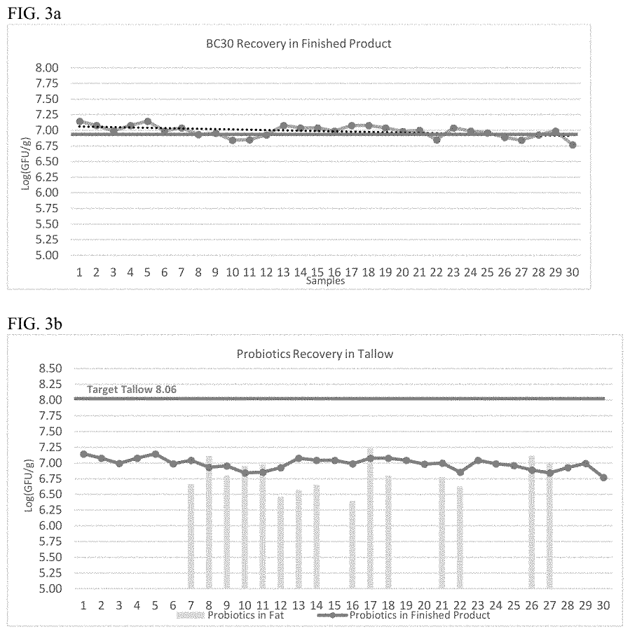

The first test with BC30 showed an acceptable recovery of probiotics in the finished product with a range of Log (CFU/g) values from 6.77 to 7.15 compared to the target value of 6.98 (FIG. 3a). The samples showed a slightly negative trend line, which might indicate the concentration of probiotics in fat was lower at the end of the trial. The calculated amount of probiotics in fat was 8.06 log, and the samples averaged 1.25 log below the target (FIG. 3b).

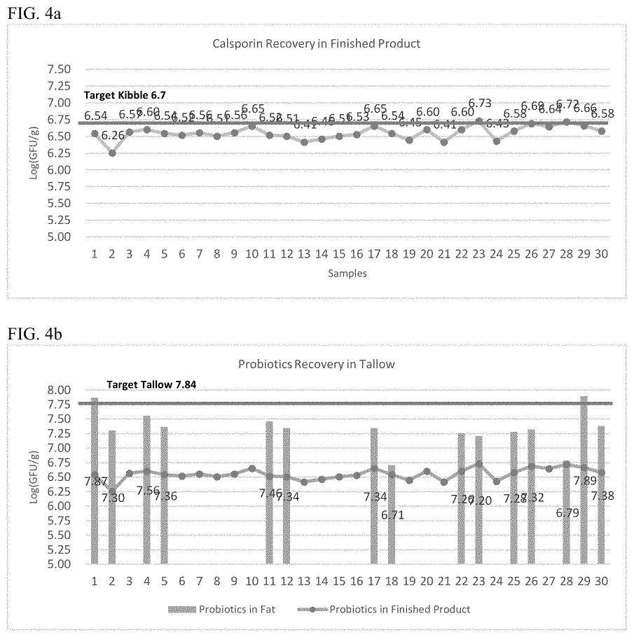

The second test of this trial evaluated the process for recovery of probiotic in kibbles coated with Calsporin®. The recovery was slightly lower than the expected level (FIG. 4a). The recovery of probiotics in fat was better when using Calsporin® than BC30, but still below the expected level (FIG. 4b).

1.5 Trial: Test In-Line High Shear Mixer

An assessment of using the high shear mixer to promote a uniform distribution of powder inside the fat was evaluated. The mixer was an in-line mixer and recirculated liquid from the batch tank through the mixer at high velocity. The mixer was configured with a hopper where the powder is fed, and when a valve in the bottom of the hopper was opened, all the powder was pushed into the liquid stream. As the powder and liquid were introduced directly into the high shear zone of the mixer, they were instantaneously combined by an intense mechanical and hydraulic shear. The mixer can handle flow rates up to 500 lb/min.

The tank had 90 Gal capacity with heated walls, and a conventional agitator on the top lid. In all tests, the tank was filled with 450 lb of fat from 1% to 2% of probiotics. The effect of acidified fat in the probiotics survival was also evaluated.

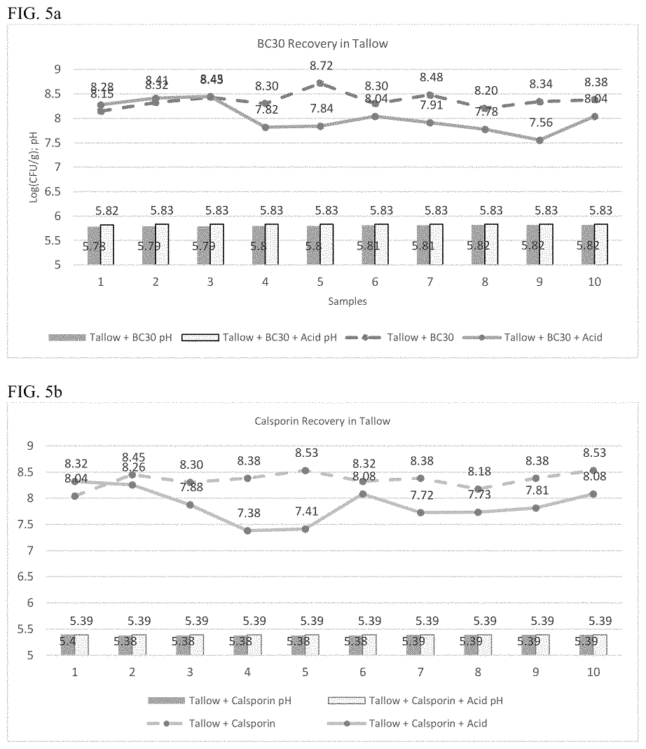

FIGS. 5a and 5b show a comparison of the recovery of probiotics in regular fat and acidified fat, as well as the pH difference for each test. The pH reduction was insignificant, and the time the cells were in contact with the acidified fat was less than 20 minutes.

1.6 Trial: Process Capability of System

The process was essentially the same from the previous trials, but one pump was dedicated to re-circulate fluid back to the batch tank, and a second pump was used for dosing. The re-circulating pump ran at full speed and pumped around 15 lb/min. The combination of re-circulation and mixing at the same time kept the solids in suspension. By the end of the trial, a minimum amount of solids accumulated in the internal wall and bottom of the tank. A ball valve was installed in the loop and used as a back pressure valve. The re-circulation and dosing pumps were manually adjusted to the target flow rate.

The trial results were consistent and showed probiotics recovery in the finished product close to the calculated target value with losses varying from 0 to 0.24 Log 10.

The recovery of probiotics in the finished product had an average loss of just 0.12 log.

The second test had chicken fat as the carrier for the BC30. This trial resulted in the highest recovery of probiotics in the finished product and the most stable process.

The trial also evaluated the impact of the acidified fat in the recovery of probiotics. The fat with 1% of 1N solution of lactic acid increased the pH by 0.03

The tests using Calsporin® also showed near target recovery in the finished product. The use of acidified lard as the carrier of probiotics did not show a considerable difference as compared with samples coated with regular lard.

Tables 6 and 7 show a summary of the results from the BC30 and Calsporin® Examples, respectively, described above and includes information about the formulated dosing level of probiotics and how the probiotics target was calculated.

TABLE 6
BC30 Target Calculations and Average Recovery

| | (−) Lactic Acid | | | (+) Lactic Acid | |
|---|---|---|---|---|---|
| | Tallow | Chicken | Lard | Tallow | Chicken |
| Finished Product min Log(CFU/g) | 6.12 | 6.12 | 6.12 | 6.12 | 6.12 |
| Pure Probiotic Powder (CFU/g) | 2.80E+10 | 2.80E+10 | 2.80E+10 | 2.80E+10 | 2.80E+10 |
| Pure Probiotic Powder Log(CFU/g) | 10.45 | 10.45 | 10.45 | 10.45 | 10.45 |
| Probiotics in Finished Product (%) | 0.02786 | 0.02786 | 0.02786 | 0.02786 | 0.02786 |
| Target Dosing (CFU/g) | 7.80E+06 | 7.80E+06 | 7.80E+06 | 7.80E+06 | 7.80E+06 |
| Target Dosing Log(CFU/g) | 6.89 | 6.89 | 6.89 | 6.89 | 6.89 |
| Avg Probiotic Recovery | 6.77 | 6.89 | 6.83 | 6.65 | 6.84 |

TABLE 7
Calsporin ® Target Calculations and Average Recovery

| | (−) Lactic Acid | | | (+) Lactic Acid |
|---|---|---|---|---|
| | Tallow | Chicken | Lard | Lard |
| Finished Product min Log(CFU/g) | 6.12 | 6.12 | 6.12 | 6.12 |
| Pure Probiotic Powder (CFU/g) | 3.70E+10 | 3.70E+10 | 3.70E+10 | 3.70E+10 |
| Pure Probiotic Powder Log(CFU/g) | 10.57 | 10.57 | 10.57 | 10.57 |
| Probiotics in Finished Product (%) | 0.01393 | 0.01393 | 0.01393 | 0.01393 |
| Target Dosing (CFU/g) | 5.15E+06 | 5.15E+06 | 5.15E+06 | 5.15E+06 |
| Target Dosing Log(CFU/g) | 6.71 | 6.71 | 6.71 | 6.71 |
| Avg Probiotic Recovery | 6.55 | 6.51 | 6.60 | 6.53 |

The disclosure herein describes a novel method for coating kibbles with probiotics. In an embodiment the disclosure describes a process using fat as the probiotic carrier instead of powder digest. This method could be applied using liquid animal digest in dog formulas.

The system is efficient to promote a uniform distribution of probiotics into fat and also to keep it in suspension. The solution was kept in the tank for a few hours without observed variation in the results. The control of the coater was modified to adjust the flow from two different streams, and the probiotics count in the finished product was accurate. The process is versatile enough to handle different powders and viscosities, as well as to run in a wide operating range.

The different fats used in the tests did not affect the recovery of probiotics in the finished product, nor did using acidified fat as the carrier. Differences were not observed in the recovery of viable cells for kibbles coated with BC30 or Calsporin®, and the average probiotics losses in the coated kibbles was 0.13 Log 10 (CFU/g). The spore forming probiotics are sensitive to heat, moisture and low pH; and encapsulating the probiotics in fat contributes significantly to prevent stimulating the germination of the inactive spores. Nevertheless, having probiotics in a fat solution at factory nominal temperature of 165° F. (74° C.) for a long period of time may cause probiotics losses.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A method of making a pet food product, the method comprising:
mixing (a) a powder comprising one or more probiotics and (b) a first portion of liquid lipid using a high shear mixer, to form a liquid mixture comprising the one or more probiotics dispersed in the first portion of liquid lipid;
transferring the liquid mixture to a day tank
mixing a second portion of liquid lipid with the liquid mixture from the day tank, using a static mixer, at a position in a fluid line downstream from the day tank and upstream from a coater, to form a coating composition comprising the one or more probiotics and the first and second portions of liquid lipid, and
coating a food kibble with the coating composition using the coater, to form the pet food product.

2. The method of claim 1, wherein the mixing (a) a powder comprising one or more probiotics and (b) a first portion of liquid lipid comprises a batch tank configured with the high shear mixer.

3. The method of claim 2, wherein the high shear mixer is configured within the batch tank.

4. The method of claim 2, wherein the high shear mixer is configured in-line with the batch tank.

5. The method of claim 1, wherein the coater is a batch coater.

6. The method of claim 1, wherein the coater is a continuous coater.

7. The method of claim 1, wherein the day tank comprises an agitator and a recirculation loop.

8. The method of claim 7, wherein the recirculation loop comprises a pump and a recirculating of the liquid mixture comprises using the pump.

9. The method of claim 1, wherein the coating of the food kibble comprises spraying the coating composition onto the food kibble using the coater.

10. The method of claim 2, further comprising a storage lipid tank, wherein the storage lipid tank provides the first portion of liquid lipid, and the method comprises transferring the first portion of liquid lipid from the storage lipid tank to the batch tank.

11. The method of claim 10, wherein the storage lipid tank also provides the second portion of liquid lipid, and the method comprises transferring the second portion of liquid lipid from the storage lipid tank to the position in the fluid line, downstream from the day tank and upstream from the static mixer.

12. The method of claim 11, wherein a combination of the second portion of liquid lipid and the liquid mixture from the day tank is subjected to homogenization in the static mixer in the fluid line to form the coating composition.

13. The method of claim 1, wherein a concentration of the one or more probiotics in the liquid mixture is from about 1.5% to about 15%.

14. The method of claim 1, wherein the coating composition has a total fat volume defined by the first and second portions of liquid fat, and the first portion of liquid fat mixed with the powder in the high shear mixer is about 1% to about 95% of the total fat volume of the coating composition.

15. The method of claim 1, wherein the liquid lipid is a fat.

16. The method of claim 15, wherein the fat is an acidified fat comprising an organic acid.

17. The method of claim 1, wherein the liquid lipid is an oil.

18. The method of claim 1, wherein the liquid lipid is selected from the group consisting of tallow, chicken fat, edible lard, vegetable oil or mixtures thereof.

19. The method of claim 1, further comprising dosing the powder into the batch tank or the high shear mixer using a metered feeder or manual feeder.

20. The method of claim 1, wherein the powder comprising the one or more probiotics does not contain any other active ingredient.

21. The method of claim 1, wherein the first and second portions of liquid lipid are respectively dosed into the batch tank and the fluid line without any other ingredients in the first and second portions of liquid lipid.

22. The method of claim 1, further comprising controlling a flow rate of the liquid mixture into or through the fluid line by a first dosing pump, based on data from a flow meter in the fluid line indicative of probiotic concentration in the liquid mixture.

23. The method of claim 1, further comprising controlling a flow rate of the second portion of liquid lipid into or through the fluid line by a second dosing pump, such that the flow rate of the liquid mixture and the flow rate of the second portion of liquid lipid achieve a concentration of the one or more probiotics in the coating composition that is substantially equal to a predetermined target concentration of the one or more probiotics.

24. A coated pet food kibble made by the method of claim 1.
